(19) United States
(12) Patent Application Publication
(10) Pub. No.: US 2016/0098532 A1
(43) Pub. Date: Apr. 7, 2016

(54) HEALTHCARE PROTOCOLS AND HEALTHCARE PLANNING SYSTEMS AND METHODS

(71) Applicant: True Health Diagnostic Management, LLC, Frisco, TX (US)

(72) Inventor: Chris Grottenthaler, Frisco, TX (US)

(21) Appl. No.: 14/870,292

(22) Filed: Sep. 30, 2015

Related U.S. Application Data
(60) Provisional application No. 62/058,581, filed on Oct. 1, 2014.

(51) Int. Cl. G06F 19/00

(52) U.S. Cl. CPC G06F 19/3443; G06F 19/322

(57) ABSTRACT

Technology is disclosed for generating patient-specific healthcare protocols and systems and methods for generating and providing patient-specific healthcare protocols for facilitating medical examinations.

### PRIORITY CLAIM

This application claims priority to U.S. Provisional Patent Application Ser. No. 62/058,581, filed Oct. 1, 2014, the entire contents of which is incorporated herein by reference and relied upon.

### TECHNICAL FIELD

The present application relates generally to healthcare planning systems and methods including systems and methods for generating patient-specific healthcare protocols, health awareness and/or wellness treatment plans through a computing application.

### BACKGROUND

Routine medical examinations are performed on a regular basis and are recommended on an annual basis by medical practitioners in the United States. Healthcare professionals as well as payers (e.g., health insurance companies, Medicare, Medicaid, etc.) are incentivized to promote general wellness of their clients/patients through proper diagnostic screenings and individualized prevention and treatment plans.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a block diagram of a computer network environment within which some embodiments of the present technology can be implemented;

FIG. 2 is a block diagram further explaining certain components and functionalities thereof in a server, which can be the server 130 of FIG. 1 in accordance with some aspects of the present technology;

FIGS. 3A-3E illustrate a user interfaces which can be generated by the server of FIG. 1 for facilitating a login and data entry activities to the healthcare planning system in accordance with some embodiments of the present technology;

FIGS. 4A-4D illustrates user interfaces which can be generated by the server of FIG. 1 for facilitating obtaining patient-specific data in accordance with some embodiments of the present technology;

FIGS. 5A-5F illustrate a user interface which can be generated by the server of FIG. 1 for facilitating a login and data entry activities to the healthcare planning system via a mobile device application in accordance with additional aspects of the present technology;

FIG. 6 is a flow diagram illustrating a routine for generating a patient-specific healthcare protocol in accordance with an embodiment of the present technology.

FIG. 7 is a diagrammatic representation of a machine in the example form of a computer system within which a set of instructions, for causing the machine to perform any one or more of the methodologies discussed herein, can be executed.

### DETAILED DESCRIPTION

Systems and methods are provided herein that enable generation of a patient-specific healthcare protocol for facilitating medical examinations and/or medical care visits. In various embodiments, the patient-specific healthcare protocol can be automatically generated and provided to a client user and/or other medical personnel for improving routine and non-routine care of patients such as patient-specific diagnostic screening and health improvement or disease prevention recommendations. The patient-specific healthcare protocol can be based upon patient-specific information (e.g., age, gender, ethnicity, previous or current medical conditions, recent laboratory test results, family health data, current medications and/or supplements. The patient-specific healthcare protocol can also be based upon general wellness knowledge information and previously acquired information relating to patient population statistics, medical care best practices, and health-based analysis and benefits resulting from implementation of healthcare protocols generated over time and based on data from a wide range of participating patients. Briefly described, the present technology includes processing and aggregating patient-specific data, analyzing the patient-specific data to create healthcare protocols associated with a patient's medical profile, and delivering, to the client user, a patient-specific healthcare protocol for facilitating medical examinations and/or on-going medical treatments and recommendations.

In certain embodiments, the present technology involves communication between a healthcare protocol system and a mobile healthcare application installed on a client's mobile device or other computing device. The mobile healthcare application enables the client user to access patient-specific information and recommended patient-specific healthcare protocols (e.g., recommended diagnostic screens, recommended treatments, recommended wellness tips, etc.) before, during and/or after medical examinations by using a client device, such as a mobile device. The patient-specific healthcare protocols are generated by the healthcare protocol system and delivered by communicating with the mobile healthcare application. The client user is further able to input additional data (e.g., observations made by medical personnel, new lab test results, etc.) into the mobile healthcare application. In some embodiments, the mobile healthcare application, in turn, can update the patient-specific healthcare protocol in real-time based on the inputted additional data.

According to one embodiment, the healthcare protocol system generates the patient-specific healthcare protocol based on a comparison of the patient's medical profile with multiple other patient profiles. In the embodiment, the healthcare protocol system looks at a healthcare data database (e.g., a data repository) for protocol-deriving information. The protocol-deriving information can be generated over time based on data from a wide range of patients that currently seek medical assistance and examinations, such as preventative examinations. In certain embodiments, the protocol-deriving information correspond to unique combinations of treatment and/or testing parameters. The healthcare protocol system can invoke search and retrieve functions to collect the appropriate protocol-deriving information and/or treatment parameters from the appropriate databases.

Additionally, the auto-generated patient-specific healthcare protocol can save time for the system to go through the different diagnostic and/or treatment scenarios for each patient that needs a healthcare protocol. Further, an auto-load feature enables reduction of error and provides a consistent set of analyses across the board for all patients. For example, whenever a new patient-specific healthcare protocol is created and commented on (e.g., implementation results reported by medical personnel), the system saves that protocol and commenting for use with other future protocols. In some embodiments, the analysis associated with the patient-specific healthcare protocol can be compiled into one report for access by the client user.

In certain aspects, the present technology provides a way that is easy for client users (e.g., medical personnel), who is not necessarily an expert in medical care and analysis, to access information critical in the administration and receiving of healthcare, thereby improving accurate diagnoses, providing consistency of treatment quality among patient groups, reducing time and healthcare costs, and providing transparency and understanding.

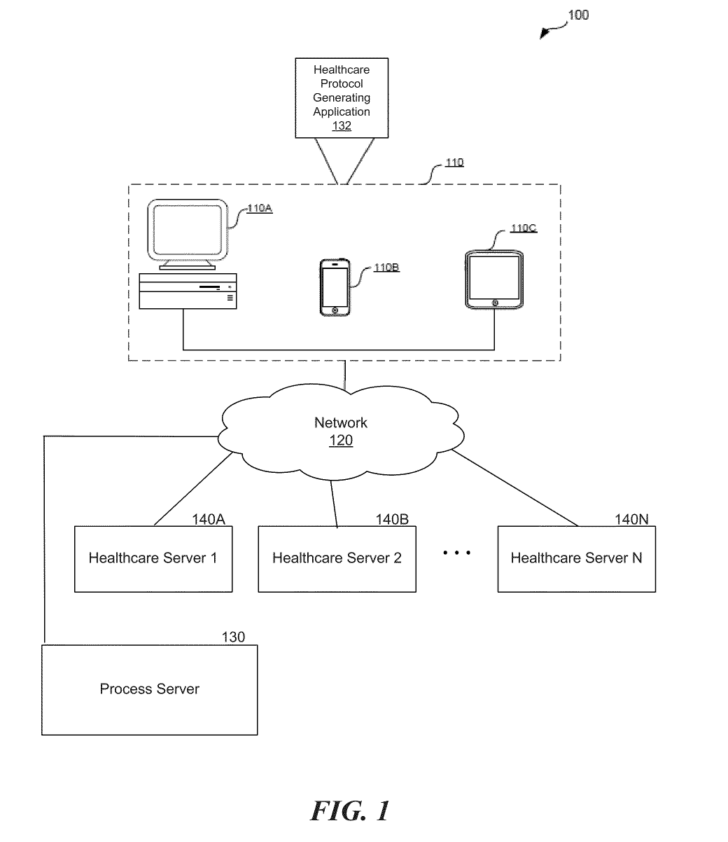

FIG. 1 illustrates a representative computer network environment 100 within which some embodiments may be implemented. The environment 100 includes a client device 110 (e.g., individually identified as client device 110A, 110B, and 110C), a network 120, a process server 130, and one more healthcare servers 140 (individually identified as healthcare server 1 140A, healthcare server 2 140B, and healthcare server N 140N) configured to capture additional patient-specific data. The client device 110, the server 130, and the remote healthcare servers 140 are coupled in communication for data transmission over the network 120. For example, the components may be connected via a twisted pair cabling network, a coax cable network, a telephone network, or any suitable type of connection network. In some embodiments, the network 120 may be wireless (e.g., which may include an IEEE 802.11 wireless network, or a data traffic network based on wireless telephony services such as 3G, 3.5G, 4G LTE and the like). The technologies supporting the communications between the client device 110 and the server 130 may include Ethernet (e.g., as described in IEEE 802.3 family of standards) and/or other suitable types of area network technologies. Note that the components of FIG. 1 are just one implementation of the computer network environment within which present embodiments may be implemented, and the various alternative embodiments are within the scope of the present technology. For example, the network 120 may include intervening devices (e.g., switches, routers, hubs, etc.) in the network 120. In some examples, the network 120 comprises the Internet.

The process server 130 may be one or more server computers or work stations that are employed by an organization for hosting a platform that functions as a channel to client users for accessing patient-specific healthcare related information (e.g., medical history records, family medical history, medical questionnaire answers, etc.) and generating a patient-specific healthcare protocol (e.g., including medically relevant tests, screenings, assessments, procedures, treatments, drug prescriptions, wellness habit recommendations, etc.) associated with the administration of healthcare to patients. The platform hosted by the process server 130 may be executed in the form of a healthcare protocol generating application 132 that can be accessible by the client device 110. The healthcare protocol generating application 132 may be a mobile application installed on a mobile device (e.g., client device 110B) or a conventional software application installed on a convention computing device, such as a personal computer (PC) (e.g., client device 110A).

In some embodiments, the healthcare protocol generating application 132, can reside on the process server 130 in communication with the one or more healthcare servers 140. In several embodiments, the one or more servers 140 and/or the process server 130 may reside in the computing cloud or other computing platform in communication with computing networks 120 (e.g., an intranet, the Internet, etc.). The healthcare servers 140 that receive the unique user-specific data from the user via mobile or conventional application portals or other health-related data collection devices (not shown), generally have programmatic application program interfaces (APIs) that enable third party applications to integrate with the servers such that these APIs provide access to data within the servers. Access to private data, such as patient and/or user-specific data may also be allowed if it is granted by the server 140 and the user/administrator. The process server 130 can collect patient-specific data from the one or more servers 140 via the servers' APIs.

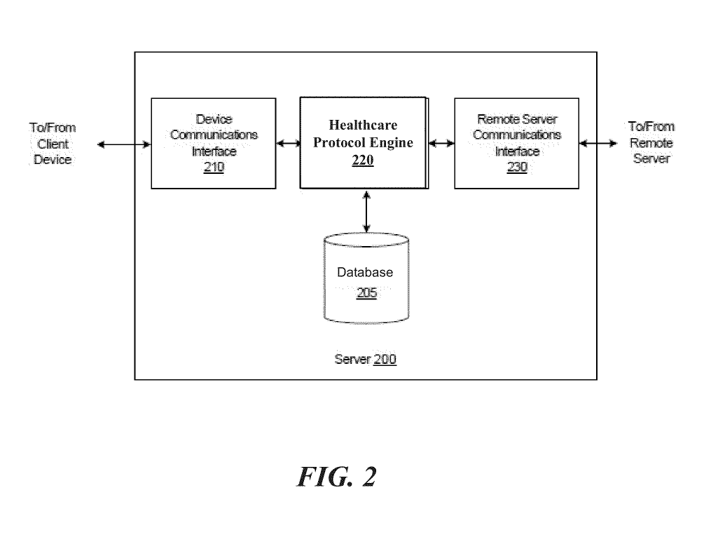

The process server 130 typically includes at least one processor and a memory, and may be further connected to one or more computers (not shown in FIG. 1 for simplicity) that carry out the various healthcare related functions via the network 120. The process server 130 is also typically equipped with or is coupled to one or more databases (e.g., database 205 of FIG. 2) for storing the various healthcare related data (e.g., medical health records, lab test findings, general medical information, analysis data, etc.) and/or data for hosting the platform that facilitates the generation of patient-specific healthcare protocols. The one or more databases can include, for example, one or more hard drives (which may be further coupled together using RAID-0, 1, 5, 10, etc.), a centralized or distributed data cluster, a cloud-storage service provider, or other suitable storage systems suitable for storing digital data. The data contained in these databases is highly confidential, and as such the secure communication to access these databases includes at least a 256 bit encryption and employs an SSL if using an Internet based communication means.

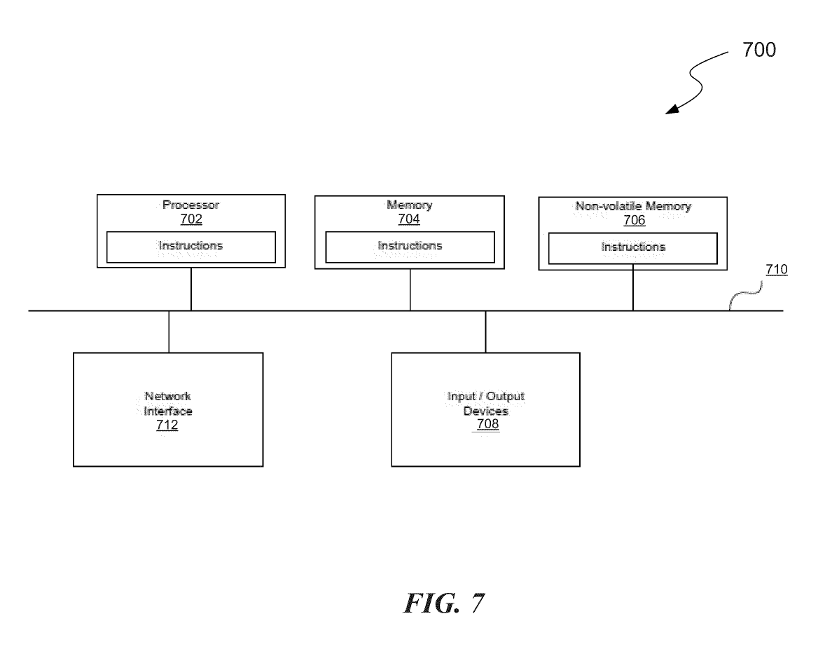

The process server 130 can include a communication interface (e.g., network interface 712, FIG. 7) that enables secure communication between the process server 130 and a variety of authorized users. As used here, the term “variety of authorized users” refers to one or more healthcare systems (e.g., a physician's medical health records computer system, a testing laboratory's medical health records computer system, a research laboratory's records computer system, etc.) and an identified recipient, such as, but not limited to, one or more healthcare system employed physicians/providers, patients, and the healthcare institution administration staff, non-employed affiliated physicians/providers and other healthcare professionals.

As used here, a “healthcare system” refers to any institution that administers or facilitates healthcare-related services including, for example, a family medical practice, a medical laboratory, a hospital, a group of hospitals, a physician group practice, a health information exchange (HIE), a health maintenance organization (HMO), an accountable care organization (ACO), a Community Health Center, an insurance company, any institution that is affiliated with a healthcare system, or any other combination of the aforementioned institution(s). In some embodiments, the healthcare system can employ one or more server computers or work stations working in coordination to provide a channel for sharing data with other servers (e.g., the process server 130). In the illustrated embodiment of FIG. 1, the healthcare system is the healthcare servers 140A, 140B, 140N, although other configurations are possible in other embodiments.

As used here, the term “physician/provider” refers to any State or Federal licensed medical practitioner such as, but not limited to, Medical Doctors (MD), Doctors of Osteopathy (DO), Naturopathic Doctor (ND), Dentists (DDS & DMD), and practitioners of Complementary and Alternative Medicine (CAM) such as, but not limited to, primary care physicians and specialty physician/practitioners such as, but not limited to, cardiologists, pulmonologists, nephrologists, neurologists, endocrinologists, gastroenterologists, dermatologists, general surgeons, ENT surgeons, cardio-thoracic surgeons, vascular surgeons, ophthalmologists, obstetricians, colorectal surgeons, dentists, oral surgeons, orthopedists, neurosurgeons, podiatrists, psychiatrists, chiropractors, acupuncturists and others, or any combination(s) thereof. The term “physician/provider” may also, for instance, refer to medical practitioners not having MD, DO, DDS, DMD or DPM licenses such as, but not limited to, dentists, optometrists, pharmacists, respiratory therapists, occupational therapists, nurses, physician extenders, nurse practitioners, physician assistants and other healthcare professionals, or any combination(s) thereof.

The client device 110, which may be used by a client user to communicate with the process server 130 to provide patient-specific data and/or in accessing the patient-specific healthcare protocol (e.g., through the healthcare protocol generating application 132), may include a laptop, a desktop, a tablet, a personal computer, a personal digital assistant (“PDA”), a smart phone, and the like. The client user can be any of the variety of authorized users discussed above. The client device 110 typically includes a display that can be used to display a user interface, and may include suitable input devices (not shown for simplicity) such as a keyboard, a mouse, or a touchpad. In some embodiments, the display may be a touch-sensitive screen that includes input functionalities.

Furthermore, although the process server 130 is illustrated in FIG. 1 (as well as described throughout the present disclosure) as a separate entity from the client device 110, it is noted that in some specific embodiments, both the client device 110 and the process server 130 can be implemented in the same computing device such as a smart phone or a tablet computer so that the standalone computing device can be the sole host of the environment 100 and practice the various techniques disclosed herein.

FIG. 2 illustrates a block diagram further explaining certain components and functionalities thereof in a server 200, which can be the server 130 of FIG. 1 in accordance with some embodiments. The server 200 includes a device communications interface 210, a healthcare protocol engine 220, and a remote server communications interface 230. The example server 200 includes various modules and storage as described below.

The device communications interface 210 is configured to facilitate communications with a client device, such as the client device 110 of FIG. 1. For example, the device communications interface 210 can receive an access request initiated by the client device (e.g., by a patient accessing a mobile healthcare protocol generating application for completing a medical questionnaire, by a physician accessing the application for requesting a patient-specific healthcare protocol based on patient-specific data). Additionally, the device communications interface 210 can provide client users with an ability to submit additional information to improve or alter the patient-specific healthcare protocol generated by the server 200. The additional information can include, for example, any medication or recent medical test results not already captured by the server 200. The server 200 also allows the client user to share the patient-specific healthcare related information provided by the server 200 with other healthcare personnel (e.g., provide access to other client devices accessible to these individuals).

The healthcare protocol engine 220 is configured to process medical information and data associated with a patient to provide detailed healthcare protocol for determining suitable screening tests, diagnostic tests, treatment plans, etc.

The server 200 can store the patient specific information and healthcare protocol in a database 205. The database 205 can include one or more databases which include, for example, one or more hard drives (which may be further coupled together using RAID-0, 1, 5, 10, etc.), a centralized or distributed data cluster, a cloud-storage service provider, or other suitable storage systems suitable for storing digital data. The data contained in these databases is highly confidential, and as such the secure communication to access these databases includes at least a 256 bit encryption and employs an SSL if using an Internet based communication means.

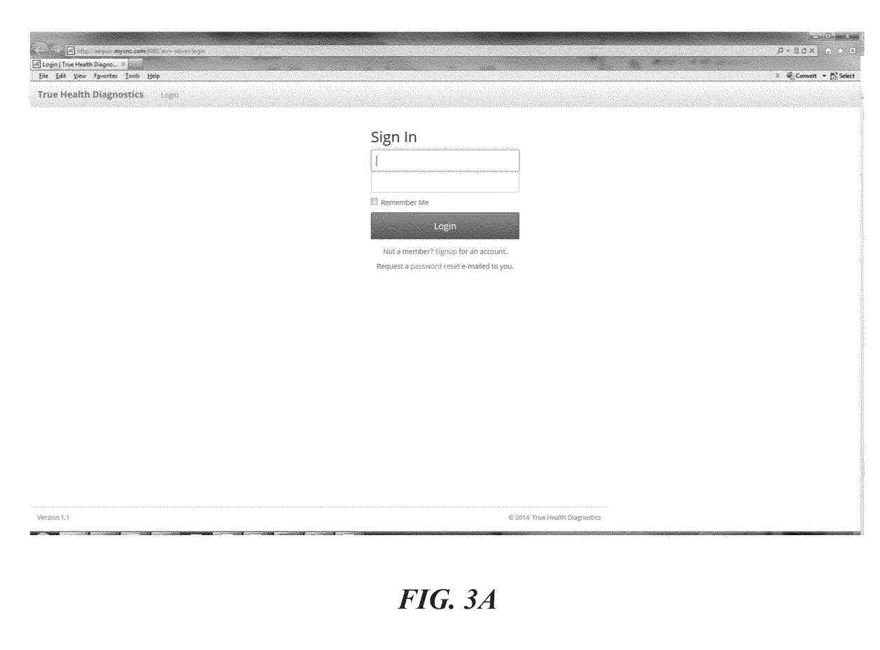

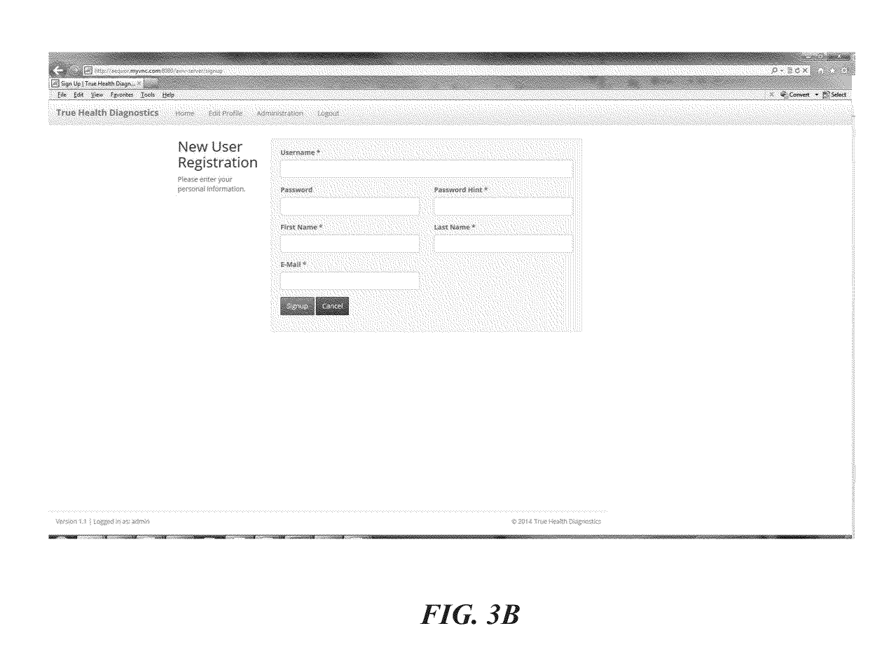

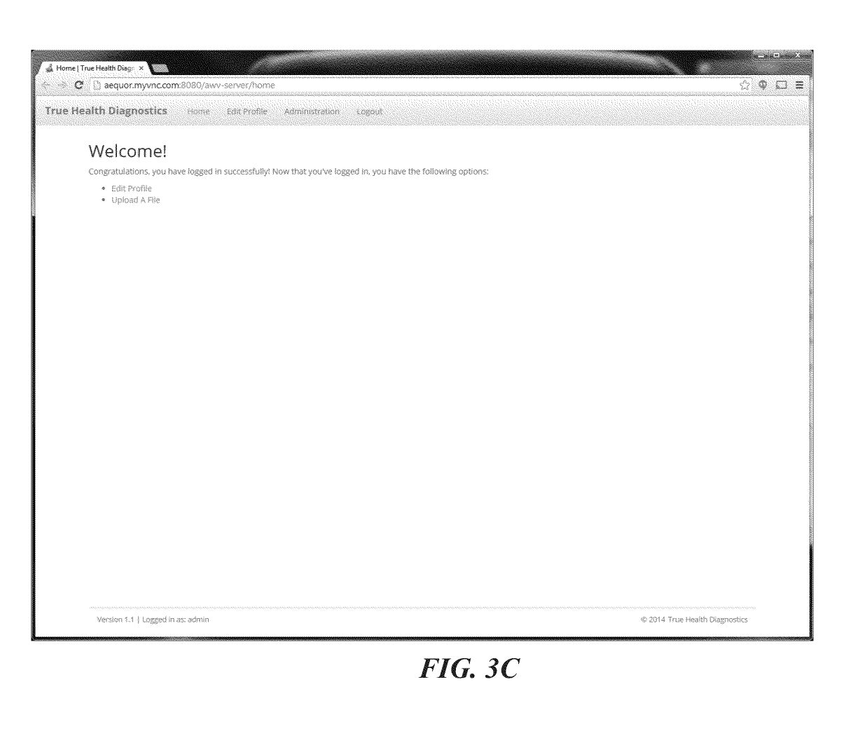

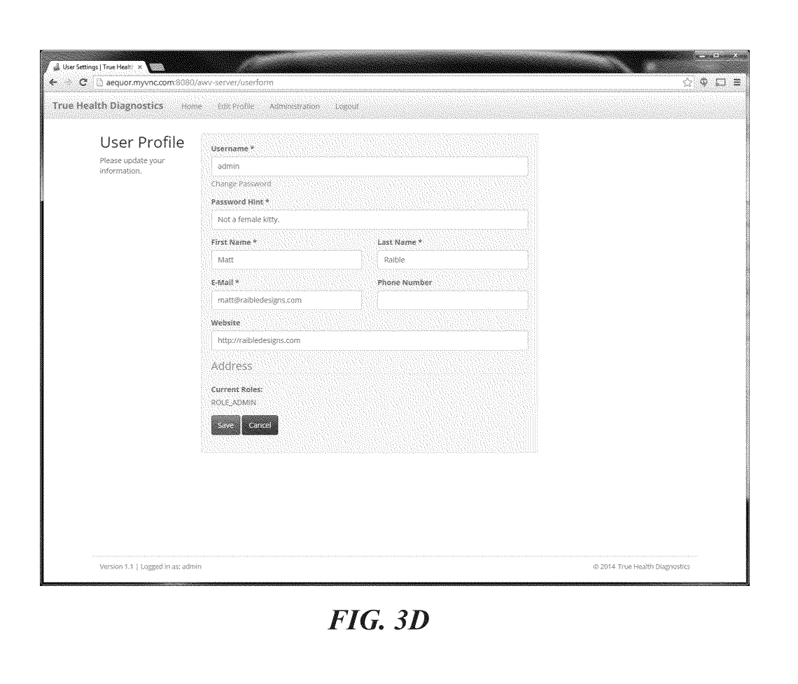

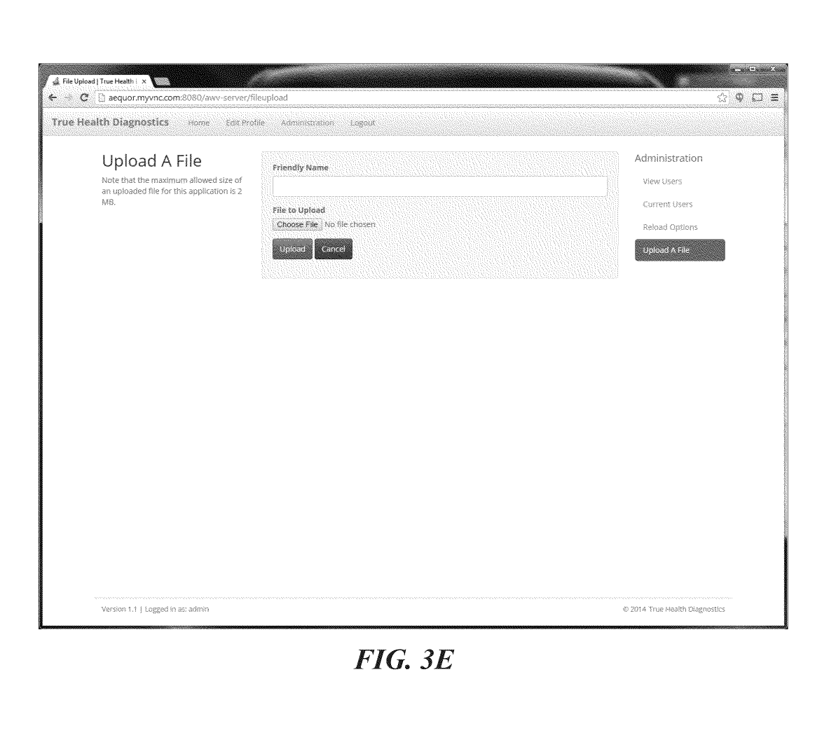

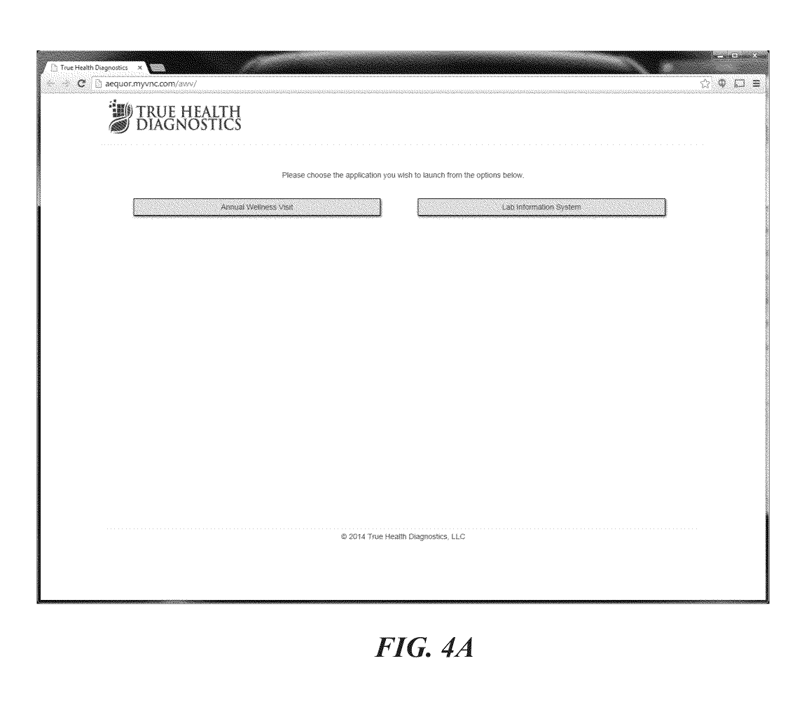

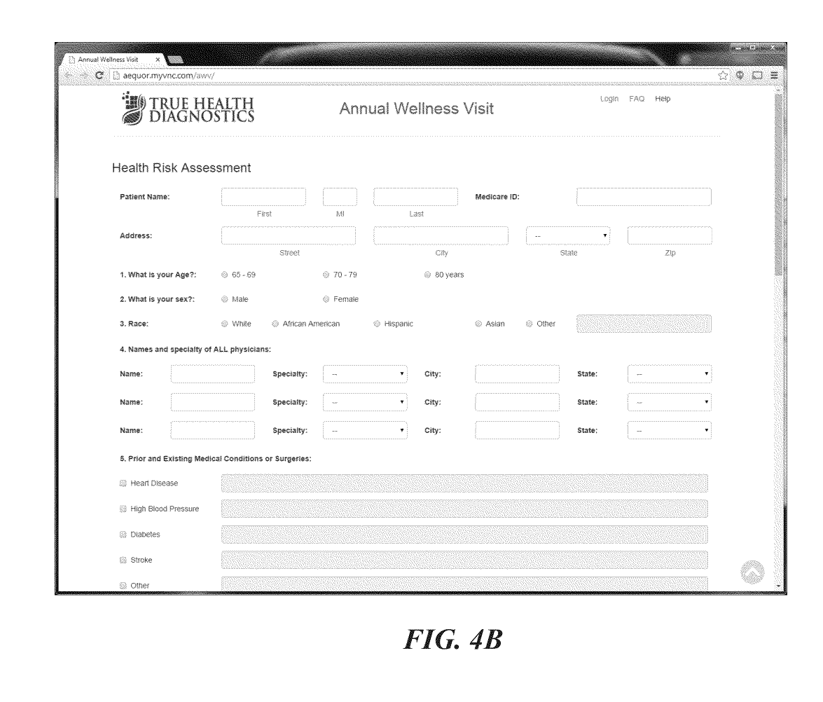

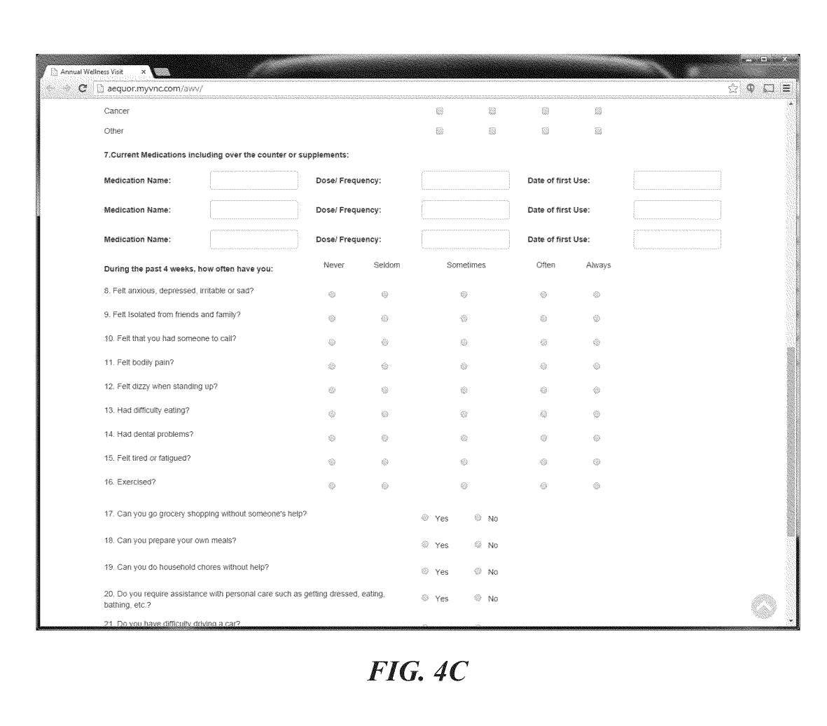

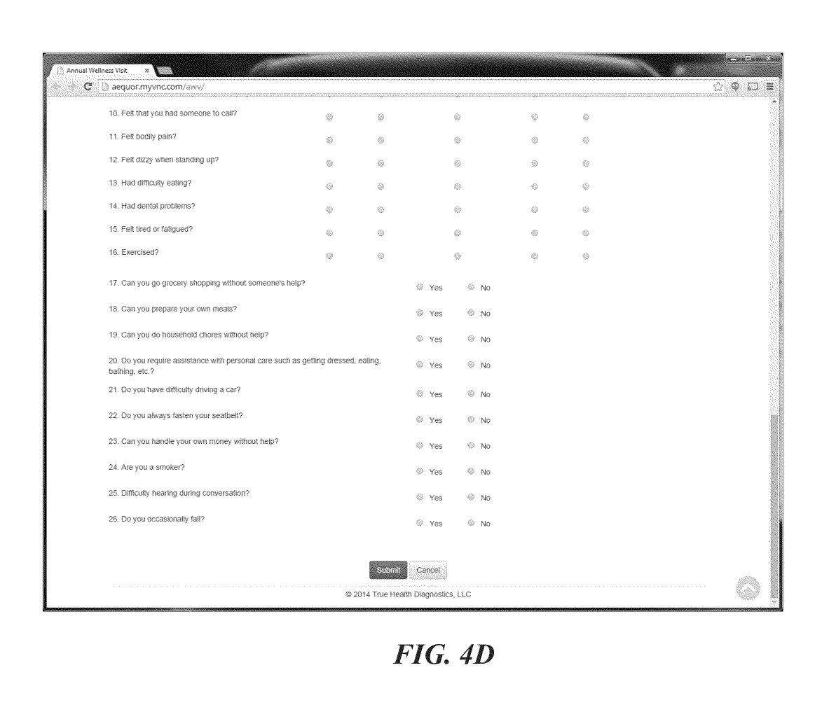

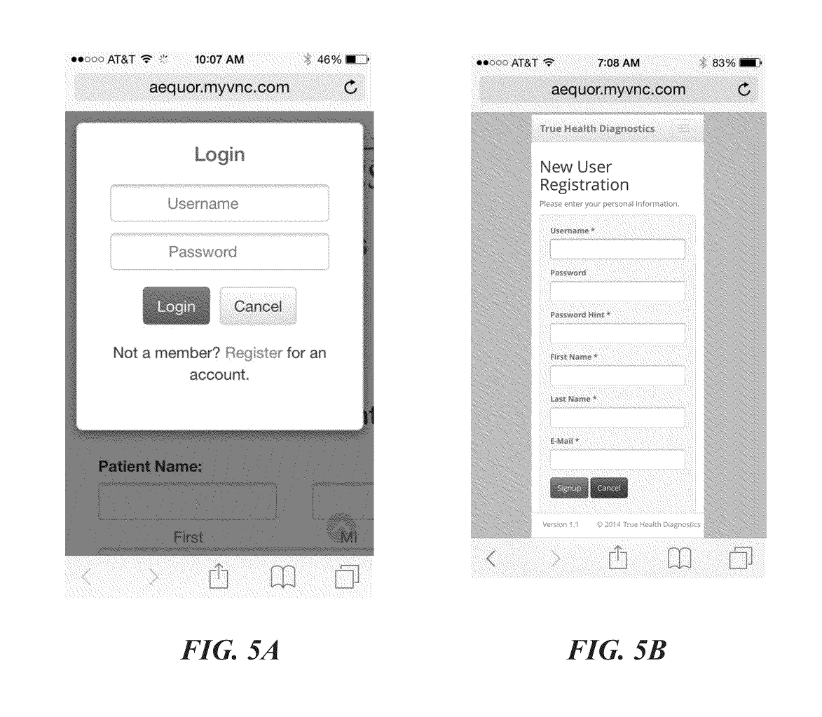

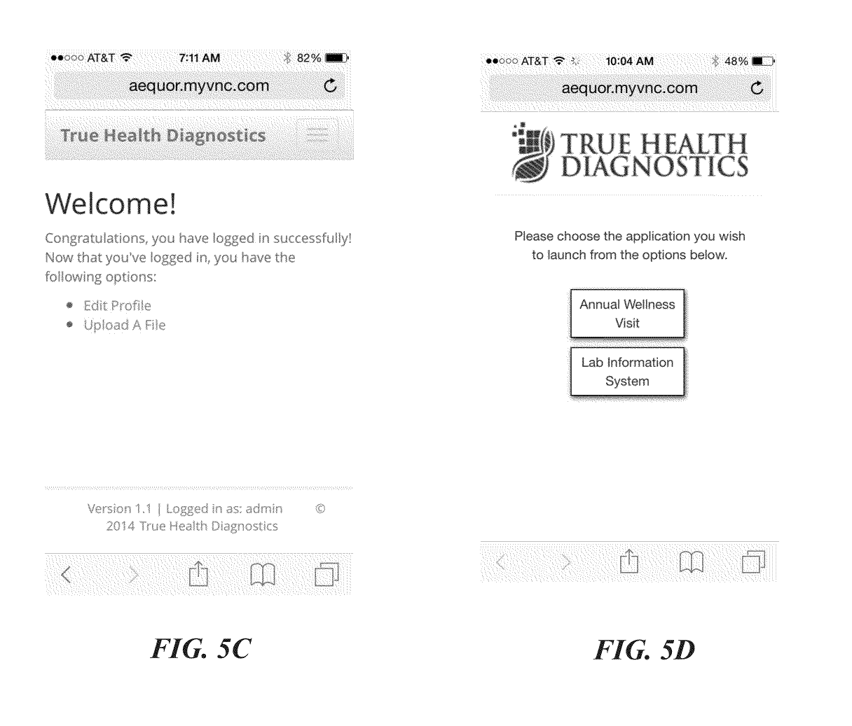

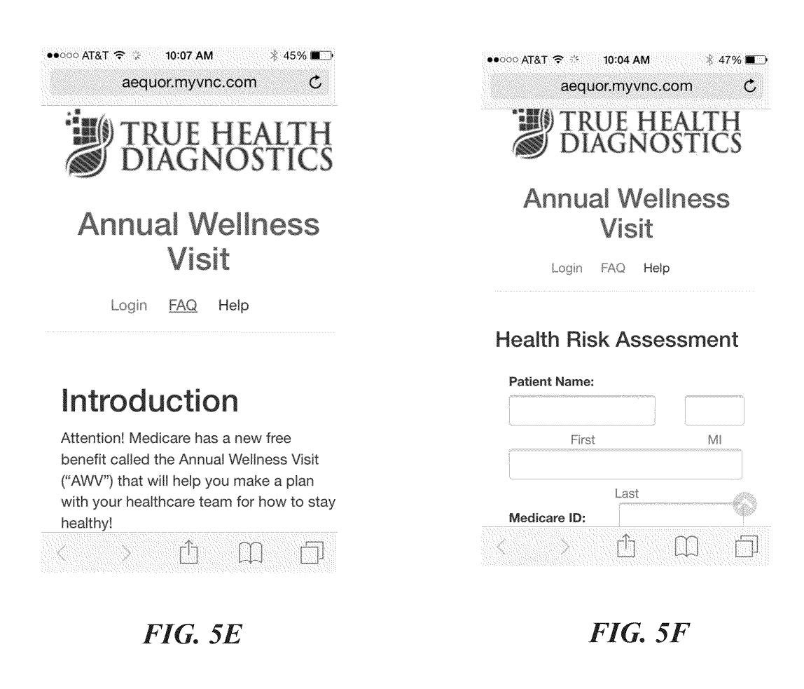

FIGS. 3A-4D illustrate various user interfaces that can be generated by the process server 130 of FIG. 1 for facilitating a healthcare protocol generating software application on a client's computing device, for example, via an internet browser in accordance with some embodiments of the present technology. FIGS. 5A-5F illustrate various user interfaces that can be generated by the server 130 of FIG. 1 for facilitating a mobile healthcare protocol generating application installed on a client's mobile device, in accordance with additional embodiments of the present technology.

FIGS. 3A-3C and FIGS. 5A-5C illustrate the user interface for facilitating a login to the healthcare protocol system via a web browser and a mobile application, respectively, and in accordance with some embodiments. New users of the system can register (FIGS. 3B and 5B) and returning client users can log in using a username and password (FIGS. 3A and 5A). Once registered and permitted to the system, a client user can edit a profile (FIGS. 3C, 3D, and 5C) and upload files (FIG. 3E) to complete or add to the information in a patient profile. In certain embodiments, user interfaces are available to patients, medical personnel and/or clerical personnel and configured to receive patient-specific information (e.g., age, gender, ethnicity, personal physician information, medical conditions, family medical history, medications, and other health-related self-reported information) in a questionnaire format (FIGS. 4A-4D and 5D-5F). In one particular example, a questionnaire (FIGS. 4B-4D and 5F) is provided via a healthcare protocol generating software application to gather patient-specific health data prior to or during a health assessment medical exam (e.g., a Medicare Annual Wellness Visit, a routine physical exam, etc.). In various arrangements, a client user or potential client user may be given a web link with access to download a mobile healthcare protocol generating application, e.g., an iPhone® app from the App Store®, as well as a registration key (if used). In some embodiments, multiple web links and/or healthcare protocol generating applications can be provided by the system. For example, a first application can be made available to patients for entering and providing patient information and a second application can be made available to medical providers for accessing the patient information, supplementing the patient information and/or for retrieving a patient-specific healthcare protocol generated by the system.

The system invokes a number of routines. While some of the routines are described herein, one skilled in the art is capable of identifying other routines the system could perform. Moreover, the routines described herein can be altered in various ways. As examples, the order of illustrated logic may be rearranged, substeps may be performed in parallel, illustrated logic may be omitted, other logic may be included, etc.

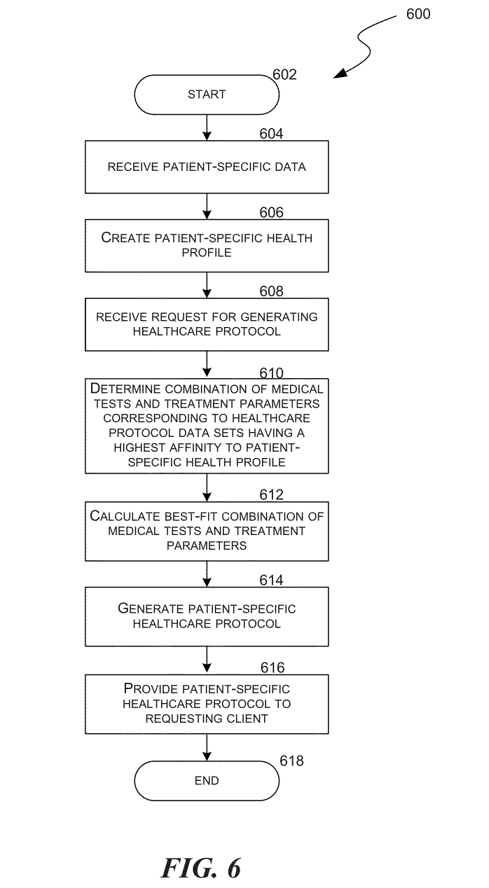

FIG. 6 is a flow diagram illustrating a routine 600 for generating a patient-specific healthcare protocol invoked by the system in some embodiments. The routine 600 can be invoked by a computing device, such as a client computer or mobile device, or in other embodiments, a server computer coupled to a computer network. In one embodiment the computing device includes the healthcare protocol generating application. As an example, the computing device may invoke the routine 600 after a client user engages a user computing device or other interface in communication with the computing device via a computer network.

The routine 600 begins at block 602 and the process server (server 130, FIG. 1) receives patient-specific data (e.g., general patient information, patient's current health status, prior health status, family medical history, medications, activity and/or health-related behaviors, etc.) (block 604) and creates a patient-specific health profile (block 606). In these embodiments, the patient-specific data can be self-reported, reported by medical personnel, objectively measured by one or more measuring devices and/or a combination of self-reporting, third-party reporting and measurements.

The process server receives a request for generating a patient-specific healthcare protocol based on the patient-specific health profile (block 608). The process server can determine combinations of medical tests (e.g., diagnostic screenings, lab tests, psychological screening, etc.) and treatment parameters corresponding to healthcare protocol data sets having a highest affinity to the patient-specific health profile (block 610). In one embodiment, the one or more healthcare protocol data sets having the highest affinity to the patient-specific health profile include healthcare protocol data sets having an affinity over a pre-established threshold affinity (e.g., a pre-established threshold percent similarity).

In some embodiments, the patient-specific healthcare protocol includes health-based recommendations for improving one or more aspects of a patient's health following compliance by the patient. At block 612, the process server calculates a best-fit combination of medical tests and treatment parameters from the combination of medical tests and treatment parameters corresponding to the one or more healthcare protocol data sets having the highest affinity. In one embodiment, the best-fit combination can be a composite of medical tests and treatment parameters corresponding to multiple healthcare protocol data sets. In another embodiment, the best-fit combination can include the medical tests and treatment parameters corresponding to a single healthcare protocol data set.

Following the generation of the patient-specific healthcare protocol (block 614), the process server provides the patient-specific healthcare protocol to the requesting client (e.g., medical personnel) via the healthcare protocol generating application (block 616). The routine 600 may then continue at block 618, where it ends.

FIG. 7 shows a diagrammatic representation of a machine 700 in the example form of a computer system within which a set of instructions, for causing the machine to perform any one or more of the methodologies discussed herein, can be executed. In alternative embodiments, the machine 700 operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine 700 can be a server computer, a client computer, a personal computer (PC), a mobile electronic user device, a tablet PC, a laptop computer, a set-top box (STB), a personal digital assistant (PDA), a cellular telephone or a smart phone (e.g., an iPhone or an Android phone), a web-enabled household appliance, a network router, switch or bridge, a (hand-held) gaming device, a music player, or any machine capable of executing a set of instructions (sequential or otherwise) that specify actions to be taken by that machine.

The computing system 700 may include one or more central processing units (“processors”) 702, main memory 704, non-volatile memory 706 (e.g., flash memory, hard disks, floppy disks, etc.), one or more input/output devices 708 (e.g., keyboard input devices, pointing devices, video display devices, etc.), and one or more network interface devices 712 for communication over a network 714, all of which are connected to an interconnect 710. The interconnect 710 is illustrated as an abstraction that represents any one or more separate physical buses, point to point connections, or both connected by appropriate bridges, adapters, or controllers. The interconnect 710, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The memory 704 and non-volatile memory 706 are computer-readable storage media that may store instructions that implement at least portions of the described technology. The instructions stored in memory 704 can be implemented as software and/or firmware to program the processor(s) 702 to carry out actions described above. In some embodiments, such software or firmware may be initially provided to the processing system 700 by downloading it from a remote system through the computing system 700 (e.g., via network interface 712).

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device 712 enables the machine to mediate data in a network with an entity that is external to the host server, through any known and/or convenient communications protocol supported by the host and the external entity. The network interface device 712 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device 712 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Various embodiments of the technology are described above. It will be appreciated that details set forth above are provided to describe the embodiments in a manner sufficient to enable a person skilled in the relevant art to make and use the disclosed embodiments. Several of the details and advantages, however, may not be necessary to practice some embodiments. Additionally, some well-known structures or functions may not be shown or described in detail, so as to avoid unnecessarily obscuring the relevant description of the various embodiments. Although some embodiments may be within the scope of the claims, they may not be described in detail with respect to the Figures. Furthermore, features, structures, or characteristics of various embodiments may be combined in any suitable manner. Moreover, one skilled in the art will recognize that there are a number of other technologies that could be used to perform functions similar to those described above and so the claims should not be limited to the devices or routines described herein. While processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. The headings provided herein are for convenience only and do not interpret the scope or meaning of the claims.

The terminology used in the description is intended to be interpreted in its broadest reasonable manner, even though it is being used in conjunction with a detailed description of identified embodiments.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

As used herein, a “module,” an “interface,” a “platform,” or an “engine” includes a general purpose, dedicated or shared processor and, typically, firmware or software modules that are executed by the processor. Depending upon implementation-specific or other considerations, the module, interface, platform, or engine can be centralized or its functionality distributed. The module, interface, platform, or engine can include general or special purpose hardware, firmware, or software embodied in a computer-readable (storage) medium for execution by the processor.

Any patents, applications and other references, including any that may be listed in accompanying filing papers, are incorporated herein by reference. Aspects of the described technology can be modified, if necessary, to employ the systems, functions, and concepts of the various references described above to provide yet further embodiments.

These and other changes can be made in light of the above Detailed Description. While the above description details certain embodiments and describes the best mode contemplated, no matter how detailed, various changes can be made. Implementation details may vary considerably, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the claims to the specific embodiments disclosed in the specification, unless the above Detailed Description section explicitly defines such terms. Accordingly, the actual scope of the claims encompasses not only the disclosed embodiments, but also all equivalents.

I/we claim:

1. A system for generating a patient-specific healthcare protocol for facilitating a medical examination comprising:
a computer network for transmitting information relating to a patient's health status;
a client computer associated with a user and in communication with the computer network;
a database connected to the computer network for storing a plurality of healthcare protocol data sets and a plurality of medical examination recommendations, wherein the plurality of healthcare protocol data sets correspond to combinations of the medical examination recommendations; and
a healthcare protocol generating application in communication with the computer network and configured to receive patient-specific data and healthcare protocol requests from the client computer, compare patient-specific data to the plurality of healthcare protocol data sets in the database, and calculate a best-fit combination of health improvement parameters from the plurality of medical examination recommendations to generate the patient-specific healthcare protocol.

2. The system of claim 1 wherein user-specific data includes one or more of general patient information, patient's current health status, prior health status, family medical history, medications, activity and/or health-related behaviors.

3. The system of claim 1 wherein the medical examination recommendations include at least one of a medical test and a treatment parameter.

4. The system of claim 1 wherein the client computer is a mobile device and wherein the healthcare protocol generating application is a mobile application.

5. The system of claim 1 wherein the medical examination is an annual wellness visit.

6. A method performed by a system for providing a patient-specific healthcare protocol, comprising:
receiving patient-specific data to create a patient-specific health profile relating to at least a patient's current health status;
receiving a healthcare protocol request; and
generating a patient-specific healthcare protocol for facilitating a medical examination,
wherein the patient-specific healthcare protocol is based on the patient-specific health profile and a plurality of healthcare protocol data sets having at least a threshold affinity to the patient specific health profile.

7. The method of claim 6, further comprising providing the patient-specific healthcare protocol through a healthcare protocol generating application on a client computing device, wherein the patient-specific healthcare protocol includes a best-fit combination of medical tests and/or treatment parameters for achieving an improved current health status.

8. The method of claim 7, further comprising receiving additional patient-specific data for modifying one or more treatment parameters of the patient-specific healthcare protocol.

9. A computer-readable storage medium storing computer-executable instructions, comprising:
instructions for receiving a patient's health data through a web-based application;
instructions for generating a patient-specific healthcare protocol based at least in part to the patient's health data; and
providing the patient-specific healthcare protocol to a user to facilitate a medical examination,
wherein the patient-specific healthcare protocol includes at a combination of medical tests and/or treatment recommendations.
